(19) United States
(12) Patent Application Publication
(10) Pub. No.: US 2023/0230476 A1
(43) Pub. Date: Jul. 20, 2023

(54) APPARATUS AND METHOD FOR PREDICTING TRAFFIC SPEED

(71) Applicants: HYUNDAI MOTOR COMPANY, Seoul (KR); Kia Corporation, Seoul (KR)

(72) Inventor: Nam Hyuk KIM, Seoul (KR)

(73) Assignees: HYUNDAI MOTOR COMPANY, Seoul (KR); Kia Corporation, Seoul (KR)

(21) Appl. No.: 17/865,306

(22) Filed: Jul. 14, 2022

(30) Foreign Application Priority Data
Jan. 20, 2022 (KR) 10-2022-0008643

(51) Int. Cl. G08G 1/08; G08G 1/01

(52) U.S. Cl. CPC G08G 1/08; G08G 1/0141; G08G 1/0129

(57) ABSTRACT

An apparatus and a method for predicting a traffic speed are disclosed. The apparatus includes a controller that learns a deep auto-encoder to output a past traffic speed and a future traffic speed by inputting the past traffic speed, and predicts the future traffic speed based on the deep auto-encoder which completes the learning, and storage that stores the deep auto-encoder which completes the learning.

### CROSS-REFERENCE TO RELATED APPLICATION

This application claims the benefit of priority to Korean Patent Application No. 10-2022-0008643, filed in the Korean Intellectual Property Office on Jan. 20, 2022, the entire contents of which are incorporated herein by reference.

### TECHNICAL FIELD

The present disclosure relates to a technology for predicting the traffic speed of each link based on a deep auto-encoder.

### BACKGROUND

In general, deep learning (or a deep neural network), which is one type of machine learning, refers to an artificial neural network (ANN) that includes a multiple hidden layer between an input layer and an output layer.

According to the structure, the problem to be solved and the purpose, and the like, such an artificial neural network may include a convolutional neural network (CNN) which is mainly used in vision field, and a recurrent neural network (RNN) which mainly deals with sequence data such as natural language, speech, and the like, and a deep auto-encoder for solving the problem of poor learning due to lack of understanding of deep learning when the neural network is multi-layered.

In this case, the deep auto-encoder includes an encoder that reduces input data and a decoder that restores the reduced input data. The deep auto-encoder learns parameters to compress and restore the input data to make the result data as identical as possible to the input data. In this case, the hidden layer serves to store compressed data corresponding to the input data.

According to a conventional technique for predicting a traffic speed based on deep learning, a model is supervised based on learning data including a pair of input data and output data (correct data), and the future traffic speed is predicted by using the model which has completed the supervised learning.

Because such a conventional technique not only does not consider the deep auto-encoder as a learning model at all, and the output data (correct data) constituting the learning data does not include the input data, when the causal relationship between the input data and the output data is weak, for example, when the output speed is significantly higher or lower than the input speed, the prediction performance of the learning model deteriorates rapidly.

The matters described in this background section are intended to promote an understanding of the background of the disclosure and may include matters that are not already known to those of ordinary skill in the art.

### SUMMARY

The present disclosure has been made to solve the above-mentioned problems occurring in the prior art while advantages achieved by the prior art are maintained intact.

An aspect of the present disclosure provides an apparatus and a method for predicting a traffic speed that can learn a deep auto-encoder to output a past traffic speed and a future traffic speed by inputting the past traffic speed, and predict the future traffic speed by using the deep auto-encoder which completes the learning, such that it is possible to predict the traffic speed with high accuracy even when the causal relationship between the past traffic speed and the future traffic speed is weak in the process of learning the deep auto-encoder, that is, the future traffic speed is significantly higher or lower than the past traffic speed.

The technical objects of the present disclosure are not limited to the above-mentioned one, and the other unmentioned technical objects and advantages will become apparent from the following description. Also, it may be easily understood that the objects and advantages of the present disclosure may be realized by the units and combinations thereof recited in the claims.

According to an aspect of the present disclosure, an apparatus for predicting a traffic speed includes a controller that learns a deep auto-encoder to output a past traffic speed and a future traffic speed by inputting the past traffic speed, and predicts the future traffic speed based on the deep auto-encoder which completes the learning, and storage that stores the deep auto-encoder which completes the learning.

According to an embodiment, the controller may further input time series speed data for a past reference time as past speed data to the deep auto-encoder, and learn the deep auto-encoder to output the time series speed data for the past reference time and time series speed data for a future reference time.

According to an embodiment, the future reference time may be longer than the past reference time.

According to an embodiment, the controller may further generate time series speed data for a past reference time and time series speed data for a future reference time based on driving information collected from probe vehicles driving a target link.

According to an embodiment, the driving information may include at least one of speed information, time information, and location information.

According to an embodiment, the controller may further determine an average speed of each probe vehicle driving a target link and determine a harmonic average of the average speed as the traffic speed of the target link.

According to an embodiment, the deep auto-encoder may perform a restoration function and a prediction function.

According to an embodiment, the deep auto-encoder may further improve feature extraction performance in a restoration process.

According to another aspect of the present disclosure, a method of predicting a traffic speed includes learning a deep auto-encoder to output a past traffic speed and a future traffic speed by inputting the past traffic speed, and predicting the future traffic speed based on the deep auto-encoder which completes the learning.

According to an embodiment, the method may further include storing the deep auto-encoder which completes the learning.

According to an embodiment, the learning of the deep auto-encoder may further include inputting time series speed data for a past reference time as past speed data to the deep auto-encoder, and learning the deep auto-encoder to output the time series speed data for the past reference time and time series speed data for a future reference time.

According to an embodiment, the learning of the deep auto-encoder may further include generating time series speed data for a past reference time and time series speed data for a future reference time based on driving information collected from probe vehicles driving a target link.

According to an embodiment, the learning of the deep auto-encoder may further include determining an average speed of each probe vehicle, and determining a harmonic average of the average speed as the traffic speed of a target link.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a traffic speed prediction system to which an embodiment of the present disclosure is applied;

FIG. 2A is a first exemplary diagram illustrating learning data used in an traffic speed prediction apparatus according to an embodiment of the present disclosure;

FIG. 2B is a second exemplary diagram illustrating learning data used in an traffic speed prediction apparatus according to an embodiment of the present disclosure;

FIG. 2C is a third exemplary diagram illustrating learning data used in an traffic speed prediction apparatus according to an embodiment of the present disclosure;

FIG. 2D is a fourth exemplary diagram illustrating learning data used in an traffic speed prediction apparatus according to an embodiment of the present disclosure,

FIG. 3 is a block diagram illustrating of a traffic speed prediction apparatus according to an embodiment of the present disclosure;

FIG. 4 is a diagram illustrating a deep auto-encoder provided in a traffic speed prediction apparatus according to an embodiment of the present disclosure;

FIG. 5A is a diagram illustrating the performance of a traffic speed prediction apparatus according to a conventional scheme;

FIG. 5B is a first exemplary diagram illustrating the performance of a traffic speed prediction apparatus according to an embodiment of the present disclosure;

FIG. 5C is a diagram illustrating the performance of a traffic speed prediction apparatus according to a conventional scheme;

FIG. 5D is a second exemplary diagram illustrating the performance of a traffic speed prediction apparatus according to an embodiment of the present disclosure;

FIG. 5E is a diagram illustrating the performance of a traffic speed prediction apparatus according to a conventional scheme;

FIG. 5F is a third exemplary diagram illustrating the performance of the apparatus for predicting traffic speed according to an embodiment of the present disclosure;

FIG. 6 is a flowchart illustrating a method of predicting a traffic speed according to an embodiment of the present disclosure; and

FIG. 7 is a block diagram illustrating a computing system for executing a method of predicting a traffic speed according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These tams are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

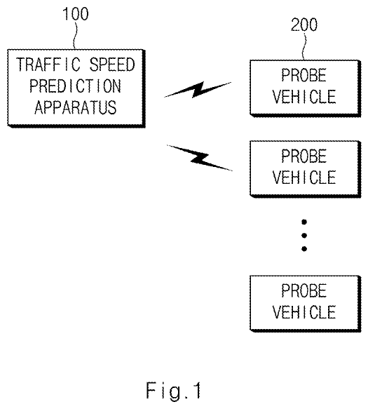

FIG. 1 is a block diagram illustrating a configuration of a traffic speed prediction system to which an embodiment of the present disclosure is applied.

As shown in FIG. 1, a traffic speed prediction system to which an embodiment of the present disclosure is applied may include a traffic speed prediction apparatus 100 and a plurality of probe vehicles 200. In this case, at least one probe vehicle 200 may be allocated to each link.

The traffic speed prediction apparatus 100 may be implemented in the form of a server or provided in a vehicle of a user, and may obtain various driving information by communicating with at least one probe vehicle 200 that has driven a target link. In this case, the driving information may include speed information, time information, location information, and the like.

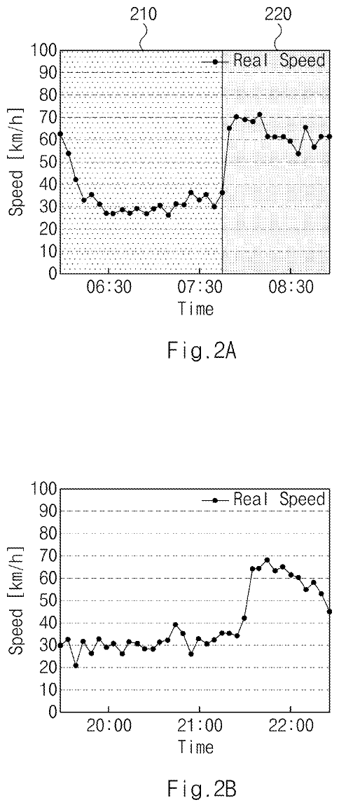

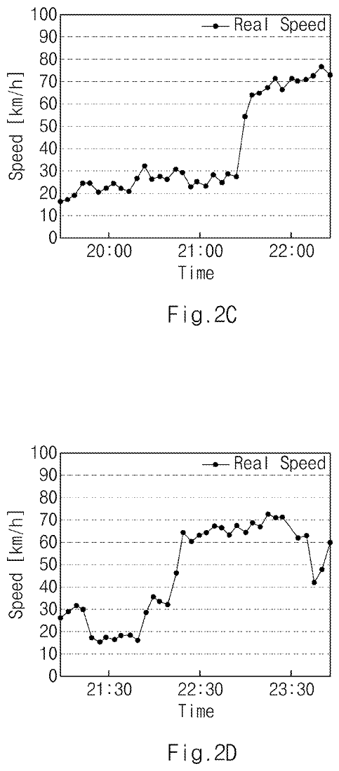

The traffic speed prediction apparatus 100 may learn a deep auto-encoder 400 to output both the past traffic speed and future traffic speed by inputting the past traffic speed, and predict the future traffic speed by using the deep auto-encoder 400 which completes the learning. In the process of learning the deep auto-encoder 400, when the causal relationship between the past traffic speed and the future traffic speed is weak, that is, even when the future traffic speed is significantly higher or lower than the past traffic speed, the traffic speed prediction apparatus 100 may predict the traffic speed with high accuracy. In this case, an example of a case in which the traffic speed rapidly changes is shown in FIGS. 2A to 2D.

The traffic speed prediction apparatus 100 may derive the past traffic speed based on driving information obtained from the at least one probe vehicle 200 that has passed through the target link. For example, when it is assumed that the probe vehicles passing through the target link are A, B, and C, the average speed of the probe vehicle A passing through the target link is V1, the average speed of the probe vehicle B passing through the target link is V2, and the average speed of the probe vehicle A passing through the link is V3, the traffic speed prediction apparatus 100 may determine the harmonic mean (average) of V1, V2, and V3 as the traffic speed of the target link.

In this case, the past traffic speed means time-series speed data for a past reference (predetermined) time, and the future traffic speed means time-series speed data for a future reference time. In this case, the past reference time is preferably 2 hours, but the embodiment is not necessarily limited thereto. In addition, the future reference time is preferably 5 hours, but the embodiment is not necessarily limited thereto.

FIG. 2A is a first exemplary diagram illustrating learning data used in an traffic speed prediction apparatus according to an embodiment of the present disclosure, and illustrates a case in which the traffic speed of a target link rapidly increases.

As shown in FIG. 2A, it may be understood that the time series data of the traffic speed collected in the morning rush hour is maintained at 30 km/h, and the congestion is resolved around 07:45 so that the traffic speed increases rapidly. Accordingly, the learning data according to the first example may be classified into the past traffic speed (i.e., the past time series speed data 210) before around 07:45, and the future traffic speed (i.e., the future time series speed data 220) thereafter. Therefore, the learning data according to the first example may include the traffic speed before around 07:45 as input data, and may include the total traffic speed (i.e., the traffic speed before and after around 07:45) as output data (correct data).

FIG. 2B is a second exemplary diagram illustrating learning data used in an traffic speed prediction apparatus according to an embodiment of the present disclosure, and illustrates a case in which the traffic speed of a target link increases rapidly.

As shown in FIG. 2B, it may be understood that the time series data of the traffic speed collected in the evening rush hour is maintained at 30 km/h, and the congestion is resolved around 21:30 so that the traffic speed increases rapidly. Accordingly, the learning data according to the second example may be classified into the past traffic speed (i.e., the past time series speed data) before around 21:30, and the future traffic speed (i.e., the future time series speed data 220) thereafter. Therefore, the learning data according to the second example may include the traffic speed before around 21:30 as input data, and may include the total traffic speed (i.e., the traffic speed before and after around 21:30) as output data (correct data).

FIG. 2C is a third exemplary diagram illustrating learning data used in an traffic speed prediction apparatus according to an embodiment of the present disclosure, and illustrates a case in which the traffic speed of a target link increases rapidly.

As shown in FIG. 2C, it may be understood that the time series data of the traffic speed collected on a rainy day maintains 25 km/h, but the rain stops around 23:00 and the traffic speed increases rapidly. Accordingly, the learning data according to the third example may be classified into the past traffic speed (i.e., the past time series speed data) before around 23:00, and the future traffic speed (i.e., the future time series speed data) thereafter. Therefore, the learning data according to the third example may include the traffic speed before around 23:00 as input data, and may include the total traffic speed (i.e., the traffic speed before and after around 23:00) as output data (correct data).

FIG. 2D is a fourth exemplary diagram illustrating learning data used in an traffic speed prediction apparatus according to an embodiment of the present disclosure, and illustrates a case in which the traffic speed of a target link increases rapidly.

As shown in FIG. 2D, it may be understood that the time series data of the traffic speed collected during the recovery process of an accident that occurs on a road is maintained at 20 km/h until the accident recovery, and then the traffic speed rapidly increased from around 22:00 when the accident is recovered. Accordingly, the learning data according to the fourth example may be classified into the past traffic speed (i.e., the past time series speed data) before around 22:00, and the future traffic speed (i.e., the future time series speed data) thereafter. Therefore, the learning data according to the first example may include the traffic speed before around 22:00 as input data, and may include the total traffic speed (i.e., the traffic speed before and after around 22:00) as output data (correct data).

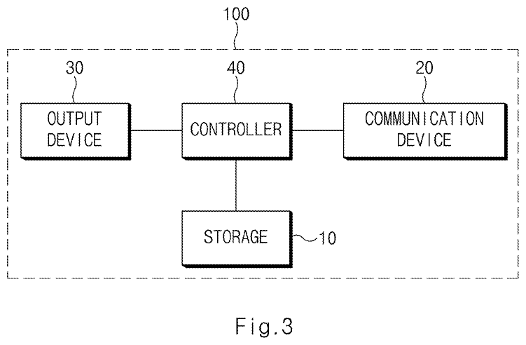

FIG. 3 is a block diagram illustrating of a traffic speed prediction apparatus according to an embodiment of the present disclosure.

As shown in FIG. 3, the traffic speed prediction apparatus 100 according to an embodiment of the present disclosure may include storage 10, a communication device 20, an output device 30, and a controller 40. In this case, depending on a scheme of implementing the traffic speed prediction apparatus 100 according to an embodiment of the present disclosure, components may be combined with each other to be implemented as one, or some components may be omitted.

Regarding each component, first, the storage 10 may store various logic, algorithms and programs required in the processes of learning the deep auto-encoder 400 to output a past traffic speed and a future traffic speed by inputting the past traffic speed, and predicting the future traffic speed based on the deep auto-encoder 400 which completes the learning.

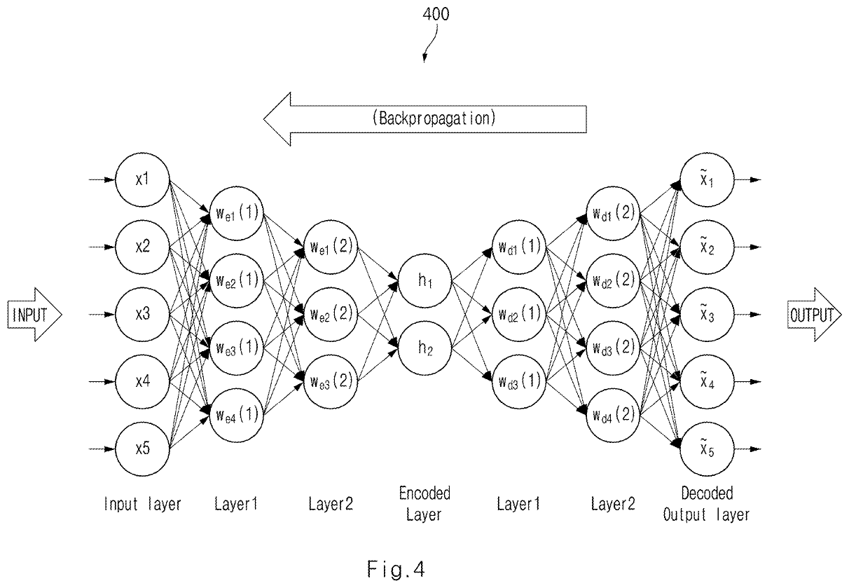

The storage 10 may store the deep auto-encoder 400 on which the learning is completed as an inference model. In this case, the deep auto-encoder 400 is as shown in FIG. 4 as an example.

FIG. 4 is a diagram illustrating a deep auto-encoder provided in a traffic speed prediction apparatus according to an embodiment of the present disclosure.

As shown in FIG. 4, the deep auto-encoder 400 provided in the traffic speed prediction apparatus 100 according to an embodiment of the present disclosure may perform deep learning to receive time series speed data 210 for a past reference time (predetermined) as past speed data and output the time series speed data 210 for the past reference time and future time series speed data 220 for a future reference time (predetermined).

The deep auto-encoder 400 may learn each layer of a neural network in stages such that the final output reproduces the initial input. In addition, in the deep auto-encoder 400, the number of nodes in a hidden layer is less than the number of nodes in an input layer or an output layer. This is because the dimensions of the input layer and the output layer (i.e., the number of nodes) are the same, but the hidden layer must have a lower dimension than the input layer or the output layer. When the dimension of the hidden layer and the dimension of the input or output layer are the same, the received data is output as it is. In this case, it becomes a meaningless neural network. As a result, because the hidden layer has a lower dimension, the deep auto-encoder 400 may extract features in the process of compressing the input data, and based on the extracted features, may provide the output data that reproduces the input data to the maximum.

The storage 10 may include at least one type of a storage medium of memories of a flash memory type, a hard disk type, a micro type, a card type (e.g., a secure digital (SD) card or an extreme digital (XD) card), and the like, and a random access memory (RAM), a static RAM, a read-only memory (ROM), a programmable ROM (PROM), an electrically erasable PROM (EEPROM), a magnetic memory (MRAM), a magnetic disk, and an optical disk type memory.

The communication device 20, which is a module that provides a communication interface with the probe vehicle 200 traveling on a target link (or target road), may periodically receive various types of driving information (i.e., probe data) from the probe vehicle 200. In this case, the probe vehicle 200 may include a telematics terminal as a vehicle terminal.

The communication device 20 may include at least one of a mobile communication module, a wireless Internet module, and a short-range communication in order to communicate with the probe vehicle 200.

The mobile communication module may communicate with the probe vehicle 200 through a mobile communication network constructed according to a technical standard or communication scheme for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTEA), 4G(4th Generation mobile telecommunication), 5G (5th Generation mobile telecommunication), and the like).

The wireless Internet module, which is a module for wireless Internet access, may communicate with the probe vehicle 200 through wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like.

The short-range communication module may support short-range communication by using at least one of Bluetooth™, radio frequency identification (RFID), infrared data association (IrDA), ultra wideband (UWB), ZigBee, near field communication (NFC), and wireless universal serial bus (USB) technology.

The output device 30 may provide the user with the traffic speed of the target link predicted by the controller 40.

The controller 40 may perform overall control such that each component performs its function. The controller 40 may be implemented in the form of hardware or software, or may be implemented in a combination of hardware and software. Preferably, the controller 40 may be implemented as a microprocessor, but is not limited thereto.

Specifically, the controller 40 may perform various controls required in the processes of learning the deep auto-encoder 400 to output a past traffic speed and a future traffic speed by inputting the past traffic speed, and predicting the future traffic speed using the deep auto-encoder 400 which completes the learning. In this case, the deep auto-encoder 400 may perform both a restoration function and a prediction function. That is, the deep auto-encoder 400 may encode and re-decode the time series speed data 210 for the input past reference time to restore the time series speed data 210 for the original past reference time, and may predict the future time series speed data 220 for a future reference time based on the time series speed data 210 for the past reference time.

Hereinafter, the operation of the controller 40 will be described in detail with reference to FIG. 4.

The controller 40 may collect various types of driving information by communicating with at least one probe vehicle 200 that travels on the target link through the communication device 20. In this case, the driving information may include speed information, time information, location information, and the like.

As the traffic speed of the target link, the controller 40 may generate time-series speed data for a reference time (predetermined) as shown in FIGS. 2A to 2D. Such time series speed data may be used as learning data used to learn the deep auto-encoder 400.

As an example, the controller 40 may use time series speed data as shown in FIG. 2A as learning data. That is, the controller 40 may classify the time series speed data into the past traffic speed (i.e., the past time series speed data 210) before around 07:45, and the future traffic speed (i.e., the future time series speed data 220) thereafter. As shown in FIG. 4, the controller 40 may input the past time series speed data 210 to the deep auto-encoder 400 as input data, and may learn the deep auto-encoder 400 such that the deep auto-encoder 400 outputs both the past time series speed data 210 and the future time series speed data 220.

Through such a learning process, the deep auto-encoder 400 may improve the feature extraction performance in the process of restoring the past time series speed data 210.

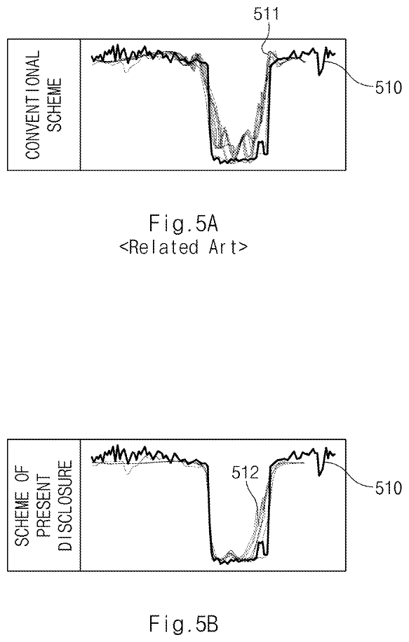

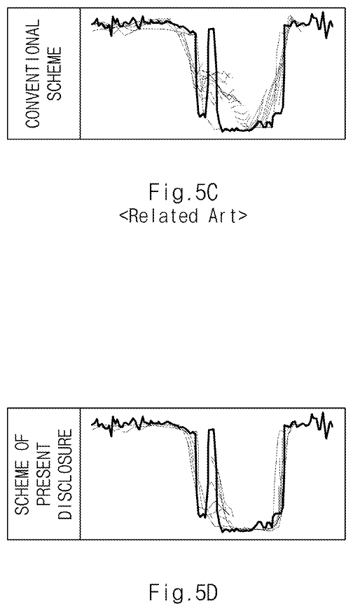

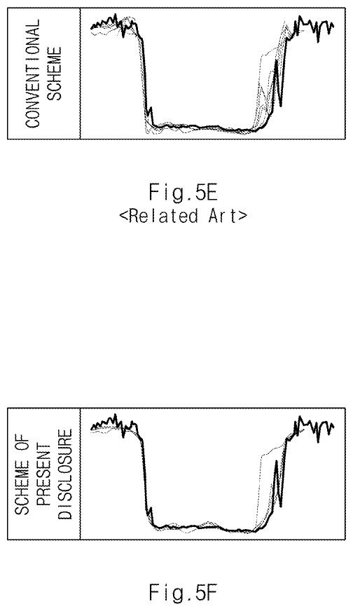

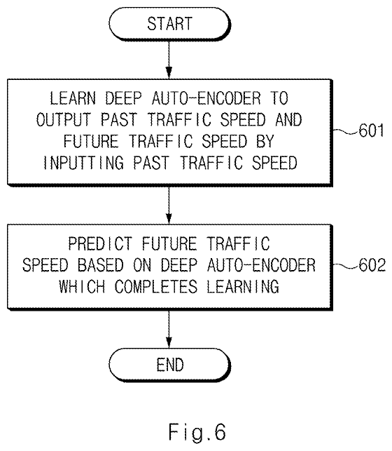

FIG. 5A is a diagram illustrating the performance of a traffic speed prediction apparatus according to a conventional scheme. FIG. 5B is a first exemplary diagram illustrating the performance of a traffic speed prediction apparatus according to an embodiment of the present disclosure. Each of FIGS. 5A and 5B shows a test result at a first point of a first highway.

In FIGS. 5A and 5B, reference numeral 510 represents a real-time traffic speed. In FIG. 5A, reference numeral 511 represents a traffic speed predicted by a conventional scheme. In FIG. 5B, reference numeral 512 represents a traffic speed predicted by a scheme according to an embodiment of the present disclosure.

As shown in FIGS. 5A and 5B, it may be understood that a predicted traffic speed 511 follows a real-time traffic speed 510 at a very low degree in a conventional scheme, and in a scheme according to an embodiment of the present disclosure, the degree to which the predicted traffic speed 512 follows the real-time traffic speed 510 is higher than in the conventional scheme.

FIG. 5C is a diagram illustrating the performance of a traffic speed prediction apparatus according to a conventional scheme. FIG. 5D is a second exemplary diagram illustrating the performance of a traffic speed prediction apparatus according to an embodiment of the present disclosure. Each of FIGS. 5C and 5D illustrates a test result at a first point of a second highway.

As shown in FIGS. 5C and 5D, it may be understood that the predicted traffic speed follows the real-time traffic speed at a very low degree in a conventional scheme, and in a scheme according to an embodiment of the present disclosure, the degree to which the predicted traffic speed follows the real-time traffic speed is higher than in the conventional scheme.

FIG. 5E is a diagram illustrating the performance of a traffic speed prediction apparatus according to a conventional scheme. FIG. 5F is a third exemplary diagram illustrating the performance of the apparatus for predicting traffic speed according to an embodiment of the present disclosure. Each of FIGS. 5E and 5F illustrates a test result at a second point of the first highway.

As shown in FIGS. 5E and 5F, it may be understood that the predicted traffic speed follows the real-time traffic speed at a very low degree in a conventional scheme, and in a scheme according to an embodiment of the present disclosure, the degree to which the predicted traffic speed follows the real-time traffic speed is higher than in the conventional scheme.

FIG. 6 is a flowchart illustrating a method of predicting a traffic speed according to an embodiment of the present disclosure.

In 601, the controller 40 learns the deep auto-encoder 400 to output both the past traffic speed and the future traffic speed by inputting the past traffic speed.

Then, in 602, the controller 40 predicts the future traffic speed based on the deep auto-encoder 400 which completes the learning.

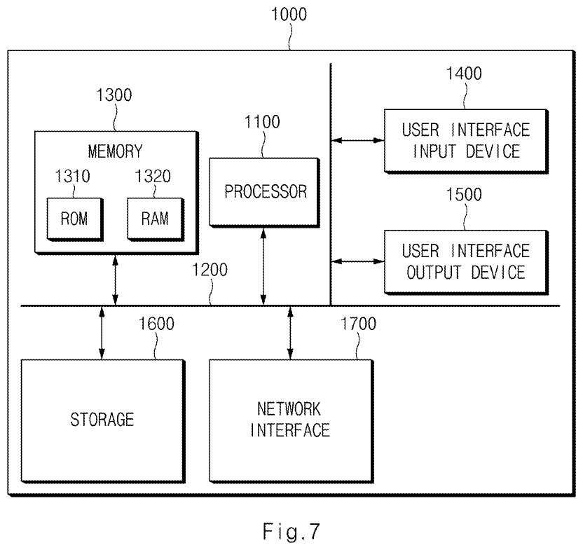

FIG. 7 is a block diagram illustrating a computing system for executing a method of predicting a traffic speed according to an embodiment of the present disclosure.

Referring to FIG. 7, a method of predicting a traffic speed according to an embodiment of the present disclosure described above may be implemented through a computing system. A computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

As described above, the apparatus and method for predicting a traffic speed according to the embodiments of the present disclosure can learn a deep auto-encoder to output a past traffic speed and a future traffic speed by inputting the past traffic speed, and predict the future traffic speed by using the deep auto-encoder which completes the learning, so that it is possible to predict the traffic speed with high accuracy even when the causal relationship between the past traffic speed and the future traffic speed is weak in the process of learning the deep auto-encoder, that is, the future traffic speed is significantly higher or lower than the past traffic speed.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for predicting a traffic speed, the apparatus comprising:
a controller configured to:
learn a deep auto-encoder to output a past traffic speed and a future traffic speed by inputting the past traffic speed, and
predict the future traffic speed based on the deep auto-encoder which completes the learning; and
storage configured to store the deep auto-encoder which completes the learning.

2. The apparatus of claim 1, wherein the controller is further configured to:
input time series speed data for a past reference time as past speed data to the deep auto-encoder, and
learn the deep auto-encoder to output the time series speed data for the past reference time and time series speed data for a future reference time.

3. The apparatus of claim 2, wherein the future reference time is longer than the past reference time.

4. The apparatus of claim 1, wherein the controller is further configured to generate time series speed data for a past reference time and time series speed data for a future reference time based on driving information collected from probe vehicles driving a target link.

5. The apparatus of claim 4, wherein the driving information includes at least one of speed information, time information, and location information.

6. The apparatus of claim 1, wherein the controller is further configured to:
determine an average speed of each probe vehicle driving a target link and
determine a harmonic average of the average speed as the traffic speed of the target link.

7. The apparatus of claim 1, wherein the deep auto-encoder is configured to perform a restoration function and a prediction function.

8. The apparatus of claim 7, wherein the deep auto-encoder is further configured to improve feature extraction performance in a restoration process.

9. A method of predicting a traffic speed, the method comprising:
learning, by a controller, a deep auto-encoder to output a past traffic speed and a future traffic speed by inputting the past traffic speed; and
predicting, by the controller, the future traffic speed based on the deep auto-encoder which completes the learning.

10. The method of claim 9, further comprising:
storing, by a storage, the deep auto-encoder which completes the learning.

11. The method of claim 9, wherein the learning of the deep auto-encoder further includes:
inputting, by the controller, time series speed data for a past reference time as past speed data to the deep auto-encoder; and
learning, by the controller, the deep auto-encoder to output the time series speed data for the past reference time and time series speed data for a future reference time.

12. The method of claim 11, wherein the future reference time is longer than the past reference time.

13. The method of claim 9, wherein the learning of the deep auto-encoder further includes:
generating, by the controller, time series speed data for a past reference time and time series speed data for a future reference time based on driving information collected from probe vehicles driving a target link.

14. The method of claim 13, wherein the driving information includes at least one of speed information, time information, and location information.

15. The method of claim 9, wherein the learning of the deep auto-encoder further includes:
determining, by the controller, an average speed of each probe vehicle; and
determining, by the controller, a harmonic average of the average speed as the traffic speed of a target link.
